(19) United States
(12) Patent Application Publication
(10) Pub. No.: US 2012/0284630 A1
(43) Pub. Date: Nov. 8, 2012

(54) Window Proxy

(76) Inventor: Frank May, Munchen (DE)

(21) Appl. No.: 13/461,066

(22) Filed: May 1, 2012

Related U.S. Application Data
(60) Provisional application No. 61/481,401, filed on May 2, 2011.

(51) Int. Cl. G06F 3/01; G06F 15/16

(52) U.S. Cl. 715/740

(57) ABSTRACT

A preferably secured server, hosting a website, connected to the internet, interacting with a user's local machine by means of executing supplemental code in the form of a browser plug-in, with the intent of modifying the capabilities of a conventional internet browser beyond its initially designed capacity, thus relieving the web designer of the limitations imposed by the original browser source code. The browser plug-in executes a process that is run in conjunction with the browser application, enabling the viewer application/process of the present invention to broadcast unrestricted code and UI elements from the local computer's operating system, and presenting the user with robust, interactive applications, framed within the current browsing application window, thus streamlining the user's experience, and providing the appearance of a secure web application, despite the reality that the browser is merely framing the complex application within the browser.

### CONTINUITY DATA

This is a non-provisional application of provisional application No. 61/481,401 filed on May 2, 2011 and priority is claimed thereto.

### FIELD OF THE PRESENT INVENTION

The present invention relates to computer application interfaces, and more specifically, concerning graphical user interfaces (GUI) employed as a framework to provide for the execution of computer processes and applications within a non-native context. More particularly, an internet browser or other application window is equipped with a supplemental browser plug-in, allowing the GUI from one process to be shown in the window of another process. In particular, complex interactive graphical and text content ordinarily beyond the scope and capacity of a conventional internet browser may be shown within the confines of the browser window.

### BACKGROUND OF THE PRESENT INVENTION

Since the dawn of the first ‘true’ internet browser in 1991, web designers and programmers have always attempted to stretch the limits presented by the parameters of the internet browser's source code. Many advancements to the browser-based internet experience have arisen through the efforts of programmers wishing to escape the initial limitations presented by any given internet browsing platform. Thankfully, much has changed since the infancy of the internet. Corporations such as Mozilla have crafted their internet browser such that it is readily modified through the use of third-party plug-ins, which run a set of code overlaid over the browser's source code, yet may still interact with the browser itself, creating the effect that the browser itself has been altered. To the common user, all of this is accomplished without the user's full comprehension of the actions going on behind the scenes.

The internet browser has become somewhat ubiquitous for computer users. Originally the “browser” was intended for document display, which is clearly seen in the acronym “HTTP” or “Hypertext Transfer Protocol”. Browsers were not originally designed to be used as a display for interactive applications. This fact has lead to the creation of a number of ad-hoc standards, enabling website developers to use a standard browser window as a pseudo-application window. These standards help overcome a majority of the original insufficiency of browsers; however, for the most complex applications these standards are not practical. Some may argue that this is not a problem, given that the user may always download an independent, custom internet application, and run it, to overcome these issues outside the realm of an internet browser.

However, over time, internet users have come to expect the illusion of control over the internet browser, such that content is expected to remain within the designated “application window” of the browser for fear of something potentially malignant. Due to viruses, advertising pop-ups, and other negative aspects of modern browsing, users have come to treat the browser as a sort of firewall or wall of protection. Users believe that anything launching a separate browser window or dialog box is suspect and untrusted. Conversely, anything remaining within the browser window is trusted.

If there were a way to seamlessly integrate complex operating system applications, such that they appear to operate solely within the framework of a conventional internet browser, users would be able to access and interact with far richer and more complex content, while remaining within the comfortable realm of the browser desktop window. This method would eliminate the need for an application, such as an internet-based game, to run independently from the browser, which would be conducive to more people wishing to participate. Individuals will be more apt to participate if the application does not appear foreign, but rather is superficially embedded within the open browser desktop window. For example, a visitor is more apt to interact with a word document provided that it may be opened and edited with the full capabilities of a word processing program, yet from within the same browser window the visitor used to navigate to the given word document.

Thus, there is a need for a method by which users may access and interact with the full potential of the operating system's application coding from within the figurative confines of a standard internet browsing window.

In a similar vein, there exists a need for a method by which any two independent application processes, preferably running on the same computer system, can be communicatively and administratively linked, in order to superimpose one application's GUI and interactive elements into the visible desktop application window of the other running computer application.

The present invention differs from any obvious solution, such as those that would venture to craft a small application designed to initiate a viewer application/process upon an event, in that the present invention moves to initiate a viewer application/process directly via a plugin.

U.S. Pat. No. 6,683,629, issued to James Friskel et al on Jan. 27, 2004, refers to “A Method in a Computer System for Embedding a Child Window in a Parent Window.” Friskel et al speaks of a parent window that is defined by a first application program running in the computer system and the child window is defined by an add-on program. Unlike the present invention, James Friskel et al employs an add-on program that operates via a “method comprising: detecting, using the add-on program, an event executed by the first application program; in response to the detecting of the event, embedding the child window in the parent window, wherein the add-on program comprises a first portion that defines the child window and a second portion that detects the event, wherein the first portion of the add-on program is associated with the first application program at the initiation in the computer system of the first application program, and wherein the second portion of the add-on program is initiated prior to the initiation of the first application program.” The second portion of the add-on program employed by Friskel et al is initiated prior to the initiation of the first application program. Conversely, the present invention employs no such tactic, and instead executes a plug-in that is then registered for handling specific types of content. It is only when a certain website employing a plug-in is loaded, that the present invention launches an application viewer. As such, it is more preferably to maintain a separate viewer application/process, rather than implementing the method proposed by Friskel et al, as far less system resources (primarily memory) are consumed when the viewer application runs within the first application.

U.S. Pat. No. 7,950,026 issued to Urbach on May 24, 2011 is for “Virtual Application Execution System and Method.” Urbach outlines a form of application overlay. Urbach differs from the present invention in that the present invention does not employ a separate application hosting engine to accomplish its function.

U.S. Pat. No. 7,694,328 issued to Amit Joshi et al on Apr. 6, 2010 is for “Systems and methods for Secure Client Applications” and relates to virtual environments, however Joshi et al does not render scenes in the same fashion as the present invention. Additionally, the present invention employs a method that minimizes the system resources required to create and present a sort of virtual environment of a foreign application within a native application.

U.S. application Ser. No. 9/736,949, published on Jun. 20, 2002 to Harrison et al. is for “System and Methods for Providing Compatibility Across Multiple Versions of a Software System.” Harrison et al concerns engineering a single application, and does not deal extensively with the notion of outputting one application's complex interactive elements such that they appear within the framework of another, less robust application.

### SUMMARY OF THE PRESENT INVENTION

The present invention, a process executed on a conventional local computer, initially downloaded to the local computer from a preferably secure server connected to the internet, provides for the implementation of more complex applications to be interactively displayed within the confines of a browser window, while managing to escape the coding restrictions presented by the makeup of the browser application itself. The present invention allows for the use of programming coding techniques and languages that typically cannot be implemented using current browser application standards due to the source code limitations imposed by the browser applications' manufacturers. The user is freed of these limitations by the present invention with the intent of providing a richer browsing experience for the user within the familiar browser desktop window. This is accomplished in such a way as to obscure the application viewer process from the user. This provides the additional benefit of quickly switching between other browser content, each session held in an individual tab within the browser application window, such as other websites, or perhaps other application instances.

The present invention, in its preferred embodiment, uses a browser application plug-in, which provides a set of codes and instructions to the local computer to modify the internet browser or other independent application superficially, allowing the GUI from a different application (process) to be viewed and interacted with via the browser application window.

The plug-in implements a child window of the browser desktop window. The viewer application/process and the browser plug-in are downloaded simultaneously to the user's local machine, and are installed upon completion. The user may optionally restart the browser application; however this is not necessary to complete the installation process. Upon completion, the user may navigate freely to sites offering content requiring the use of alternate applications, which will activate when triggered appropriately via a web extension, URL string, or other server-provided instruction. This is effectively accomplished through a direct administrative link that is established between the application viewer process and the browser application/process, enabling the viewer application/process' application core to write directly to the foreign application process child window, as if the browser desktop window was under the control of the viewer application/process. In this manner, the GUI and interactivity of the ‘foreign,’ third party application is superimposed onto the browser desktop window or other host application window acting as a proxy window within the browser desktop window for the application coding.

It is the intent of the preferred embodiment of the present invention to enrich the user's experience interacting with web content, such as a robust power-point application, or an interactive, networked full-game application, within a conventional browser desktop window, commonly found to be comfortable to the user.

### BRIEF DESCRIPTION OF THE DRAWINGS

FIG. 1 shows the interaction of processes and child windows of the present invention.

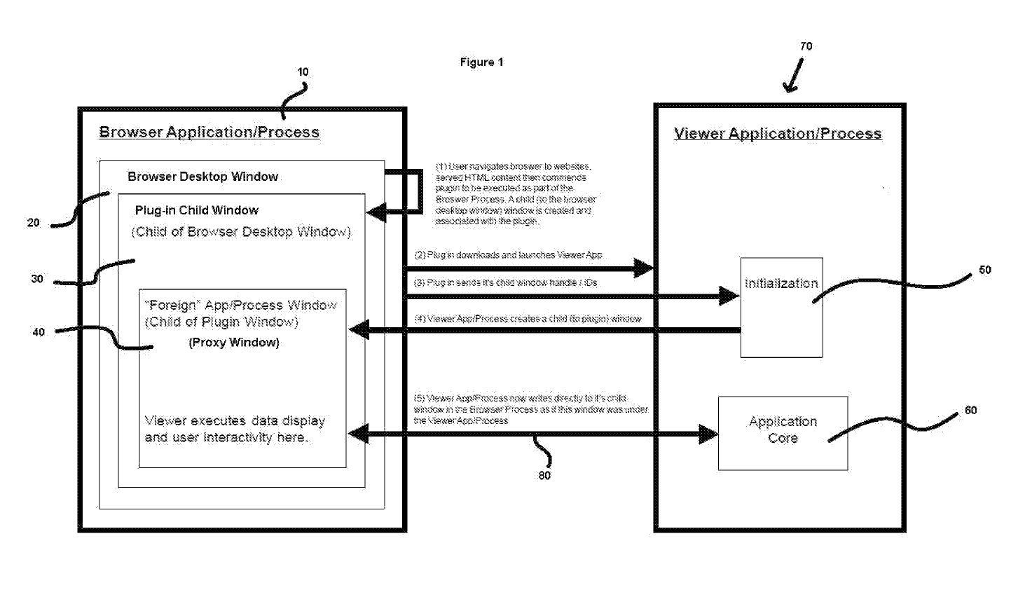

FIG. 2 displays a flow chart representing the preferred path of the user of the present invention.

### DETAILED DESCRIPTION OF THE PREFERRED EMBODIMENT

The preferred embodiment of the present invention is configured to circumvent the programming limitations presented by a conventional internet browser's rigid and fundamental source code. These limitations exist due to the imposed independence of application processes operating within a conventional operating system. The present invention deconstructs this disconnection, providing for the GUI and interactivity of a primary application to be superimposed onto a separate application's desktop window. The preferred embodiment of the present invention features the superimposition of an application's interactivity (user-interactive components) and GUI into a conventional browser desktop window (20). In effect, a user may navigate to a website (110) with a desire for a specific user experience which happens to be beyond the current technical state-of-the-art capability of conventional browser application/processes (10). The present invention employs a type of conjunctive or contemporaneous coding process required for the present invention to function, which is presented in the form of a message and download link (130) within the pre-established browser desktop window (20), providing the visitor with the option to click a download link that will download and install the browser plug-in (140) and the viewer application/process (70) itself, if necessary. The ‘foreign’ application core (60) refers to the actual program, such as Microsoft Word™, Adobe Acrobat™, or potentially any other executable program that the user wishes to run within the browser desktop window (20) frame. The viewer application/process (70) refers to the background process, enabled through the administrative link (80) created via the browser plug-in in the preferred embodiment of the present invention, as outlined below. At this point, following the download, the user is prompted to run or save the browser plug-in (130) and if necessary, the viewer application/process (70), originating from the preferably secured server hosting the web content, onto the user's local computer. In some instances, third-party software, amounting to the foreign application core (60), may need to be downloaded as well, provided the application is not already in place, in which case the plugin code will identify, download, and install the necessary third party software required for the present invention.

During the browser plug-in initialization process (50), the child window handle identification (3) code is communicated to the application core (60) of the viewer application/process (70), creating the administrative link (80) between the background application core (60) process, and the ‘foreign’ application process child window, or proxy (40). A preferred embodiment passes the window handle via the command line, if the ‘foreign’ application is started by the plug-in, or via well-known inter-process communication techniques, if the ‘foreign’ application core (60) is already running. It is via this administrative link (80) that the ‘foreign’ application child window (40) is populated with content originating from the application core (60), enabling the integration of a foreign application's processes and GUI display, as well as full user interactivity (210), into the framework of the parent browser desktop window (20).

The plug-in initialization process (50) enables the capacity for the ‘foreign’ and robust application process child window (40) to be shown within the frame of the browser desktop window (20). After installation the browser plug-in initialization process (50) is triggered to run via the HTTP <object> tag that is intended for loading plugins as part of a web page, found within the source code of the website. The actual plugin to use is indicated by an Internet Media Type (often called MIME type) identifier, for example: “application/x-spoton3dplugin”

The plug-in code is not directly integrated into the source code of the browser application/process (10) itself, but rather is executed in conjunction with the browser application/process (10) when prompted, in order to form a bridge or administrative link (80) between the browser application/process (10) and the viewer application/process (70). This is accomplished while providing the appearance that the fundamental utility of the browser desktop window (20) has been altered and enhanced to the average visitor. The plug-in is separate from the ‘foreign’ application core (60), which are in communication in order to form the transitory or intermediary bridge, known as an administrative link (80), between the browser application/process (10) and the viewer application/process (70). After the viewer application/process (10) (a background process) has formed an administrative link with the ‘foreign’ application's child window, or proxy within the browser desktop window (200), which is accomplished via the browser plug-in, the plug-in remains running in the background, despite accomplishing its primary task. The bulk of the processing is now handled by the viewer application/process (70), a hidden process running in the background, ensuring the ‘foreign’ application child window (40) or proxy is consistently displayed properly.

In order to streamline the user experience in the preferred embodiment of the present invention, the viewer application/process (70), as well as the browser plug-in initialization process (50) of the present invention, are preferably downloaded simultaneously from the secured server (150), to the user's local machine. Upon completion of the initial download and installation, the user may optionally restart (170) the browser application/process (10), however this is not necessary to complete the installation process. The viewer application/process (70) makes use of the superficially modified browser application/process (10) by superimposing and processing data output, including GUI elements, into the framework of the open browser desktop window (20), by means of the browser plug-in initialization process (50) and accompanying viewer application/process (70). After the completion of the installation the viewer application/process (70) appears to fundamentally alter the functional capacity or ability of the browser desktop window (20); but, behind what is visible to the end user, the original coding of the viewer application/process (10) is only mildly altered. The coding of the browser application/process (70) must be changed slightly in order to receive the plug-in window ID (required for establishing the administrative link between the browser application/process (10) and the viewer application/process (70)) and create its top-level window as a child window of the browser desktop window (10). Other minor changes to the viewer application/process (70) allow communicating with the plug-in code, for example to send status messages during startup. While the original source code of the browser application/process (10) remains largely intact, after the browser plug-in initialization process (50) is installed, it is added to run conjunctively with the browser application/process (10) in the background, enabling the present invention, which is executed upon each instance that the browser desktop window (20) is opened, without alerting the user, with the exception of the initial download prompt. Similarly, the viewer application/process (70) is contextually sensitive, in that it is only triggered to activate (190) when the web content navigated to by the user requires the viewer application/process (70). The user is only prompted to download the browser plug-in (130) once, when the user first navigates to a website (110), wherein the website is serving content beyond the capacity of a conventional browser (120) requiring the viewer application/process (70) of the present invention, triggering the browser plug-in to run. This simplification of code development by escaping the limits of the browser desktop window (20) itself manages to free web content authors of the burden of having to constrain their interactive content code to meet the browser requirements. Web designers and programmers are now free to author code to the more lenient operating system standards, while still displaying their work within the frame work of a browser or other target application (270).

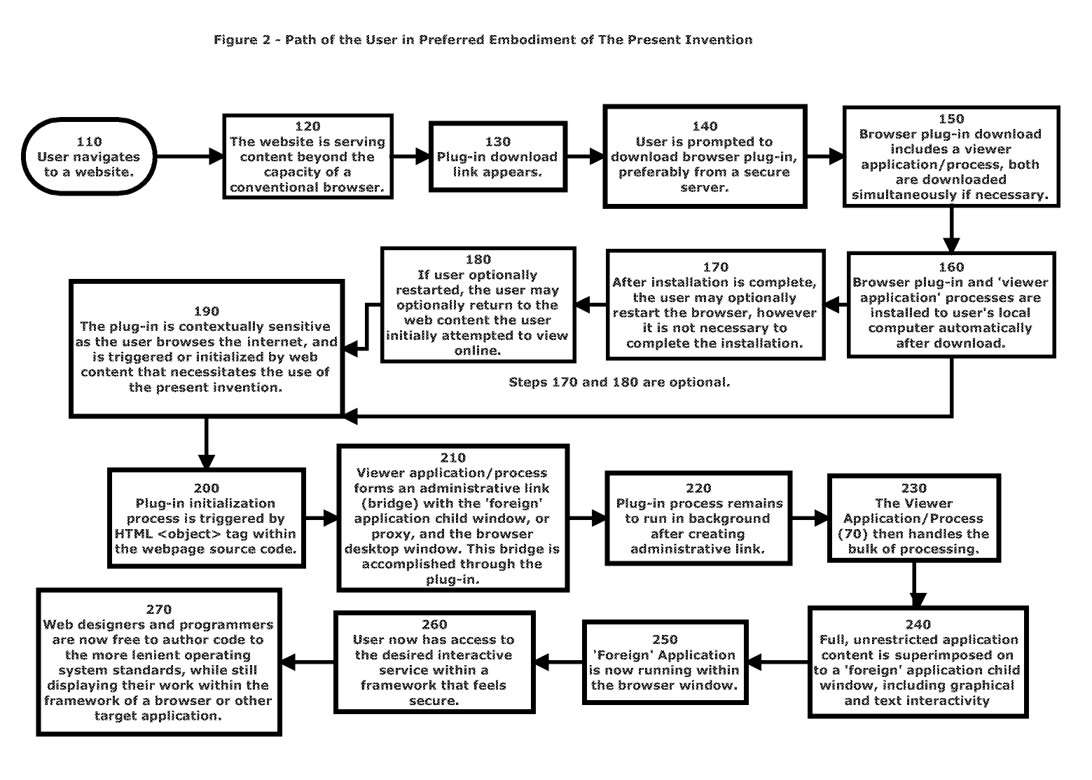

As a consequence of the nature of the administrative link (80) that is formed between the application core (60) and the ‘foreign’ application process child window, or proxy, of the preferred embodiment of the present invention, the viewer application/process (70) is required to run on the user's local machine in order to gain the benefit of writing within the operating system framework and coding structure. The viewer application/process (70) is preferably downloaded from the secured server hosting the website content in the same package as the browser plug-in (30). The simultaneous download streamlines the operation for the end user, given that only one download is required, creating the illusion that the viewer application/process (70) is simply a part of the browser plug-in and ultimately, a part of the browser itself—shown as ‘browser plug-in download includes viewer application/process, both downloaded simultaneously if necessary (150) in FIG. 2. The installation of both the browser plug-in initialization process (50) and the viewer application/process (70) to the user's local computer takes only a few moments, and is only required once per browser platform manufacturer or brand. Preferably, the Javascript code in the web page checks periodically to note if the plug-in installation has completed; then the plugin starts automatically, without requiring a restart of the browser. If the installation of the plug-in is an upgrade, such as a new version for a previously installed plugin, the process of the present invention carefully updates the version numbers in the plugin binary file name, as well as in the meta-data included within the plugin installer and within the plugin binary upon download and installation of the updated plug-in.

The same plug-in does not work for all browsers, as custom tailored plug-ins have been coded to be compatible with other application processes, such as internet browsers, in the case of the preferred embodiment of the present invention. The website hosting the plug-in download automatically detects which browser (such as Mozilla's Firefox™, Microsoft's Internet Explorer™, and Apple's Safari™ browsers) the user is using upon being prompted to download the browser plug-in, preferably from a secure server (140). Streamlining the two installations of both the browser plug in and the viewer application/process (70) might indeed require separate installations or even separate downloads for different browsers.

Upon installation and activation, an administrative link (80) is established between the ‘foreign’ application process window or window proxy (40), held within a child window of the browser desktop window (20), and the application core (60) itself, running on the user's local computer, via the triggered browser plug-in. To elaborate, the plug-in is contextually sensitive as the user browses the internet, and is triggered or initialized by web content that necessitates the use of the present invention (190). The administrative link (80) has both read and write capabilities inconsistent with the browser application process (10), enabling full interactivity for the user with a given robust, compatible application from within the proxy ‘foreign’ application process window (40). It should be understood that the processing for the ‘foreign’ application process window (40), or proxy window for the third-party application core (60) remains to be running within the viewer application/process (70) and the application core (60), not within the browser application/process (10) itself. Via the administrative link (80), mouse and keyboard events relating to the ‘foreign’ window (40) are delivered directly to the application core (60) by the operating system. These mouse and keyboard events are handled in the usual fashion specific to the operating system such that these mouse and keyboard events are incorporated seamlessly into the viewer application/process (10).

An alternate embodiment of the present invention could feature multiple ‘foreign’ application process child windows (40), which could incorporate more than one interactive third-party applications into two separate ‘foreign’ application process child windows (40) within the same browser desktop window (20) simultaneously, rather than within two separate browser desktop window (20) tabs. This could be useful for individuals wishing to compare a word document to an excel spreadsheet, while maintaining full capacity to make edits to both documents and while remaining within the browser desktop window (20). In order to accomplish this feat, the user would simply navigate to the website (110) hosting the documents the user wishes to interact with. The browser plug-in initialization process (70) is preferably triggered by an HTML ‘<object>’ tag found within the website source code (200), launching the application viewer process (70), providing for the implementation and execution of more complex operating system processes by means of the administrative link (80) established between the ‘application core’ (60) and the ‘foreign’ application process child window(s) (40).

An additional alternate embodiment of the present invention could include a universal browser plug-in, which could provide the plug-in initialization (50) for all brands of browsers, including Mozilla's Firefox™, Microsoft's Internet Explorer™, Apple's Safari™ browser, as well as other dominant browsers. A universal plug-in could be written that would automatically detect which browser platform the user is navigating with, and install itself in accordance with the browser application/process (10) developed by the manufacturer. It can also be envisioned that, in future renditions of browser application/processes (10), the supplemental coding provided by the plug-in initialization process (50) enabling the viewer application/process (70) could be included by the browser manufacturer, provided that the present invention became ubiquitous enough to become a widely accepted internet standard.

Subsequently, an additional embodiment of the present invention should encapsulate any method by which any and all independent application processes executable within a given computer system has the capacity to superimpose their user interactivity and GUI into another independent application running within the same computer system via an administrative link, created in part by a plug-in specifically written or coded for the application pair. It can also be envisioned that the application pair could be designed to function in this manner natively, establishing the administrative link without the plugin requirement. This is similar to the preferred embodiment, which features an internet browser application/process (10) as the host application process being superimposed upon by the GUI and interactive elements of a secondary application, such as the viewer application/process (70). Due to the variance and complexity of many of the software applications for modern computers, software plug-ins enabling the present invention to function often will be written specifically for the intended application pair. Indeed, the present invention need not be limited to instantiations employing browser applications/processes as a framing context for a foreign application.

Another alternate embodiment of the present invention relates to the use of the present invention in other operating systems, such as Apple's Mac OSX. Given that OSX does not readily employ the abstract notion of a conventional application ‘window,’ the process of the present invention must be implemented in a different manner. In this embodiment of the present invention, the viewer application/process (70) that is required for use with OSX renders a sequence of ‘frames’ and sends these frames over to a different version of the plug-in employed by the present invention. This alternate plug-in then draws these frames within the plug-in window. Mouse and keyboard events are captured by the plug-in, and are sent to the viewer application/process (70) via established inter-process communication techniques.

In the preferred implementation of the present invention designed for OSX, frames are passed from the application to the plug-in through the use of a dedicated buffer in the memory of the graphics card. This effectively minimizes the amount of data to be copied, and limits the strain on the system's resources. While effective, this implementation of the present invention is less efficient than that of the preferred embodiment of the present invention employed for use in Microsoft Windows operating systems. As such, frames in OSX must not be rendered to a window, but rather to a memory buffer instead. Therefore, mouse and keyboard events can not be handled as they are in the Microsoft Windows operating systems. Alternately, special code must be added in order to receive those mouse and keyboard events from the plug-in.

It should be understood that the preferred embodiment of the present invention is distinctly different from a common ‘overlay window,’ which are a well-known technology that simply places a second desktop window over an existing window, hiding or obscuring the original windows' contents. If the primary window is moved and/or resized, the ‘foreign’ application's overlay window must actively move and/or resize the overlay window accordingly. This is often visible, due to the overlay window lagging slightly behind the existing window. To be clear, instead of a mere overlay, the present invention puts the ‘foreign’ application's GUI and interactive components into a proxy window (40) inside of the existing browser desktop window (20). When the existing browser desktop window (20) is moved and/or resized, the operating system or the GUI framework layout manager (part of the host application, commonly the browser) takes care of moving and/or resizing the ‘foreign’ window, just as any other window that is part of the host application. There is no lagging behind the existing window, as the ‘foreign’ application process window or proxy window (40) is actually contained within the existing window.

The present invention is not limited to instantiating a given application into a browser desktop window (20), but rather the process may be applied to any two applications running contemporaneously on the same platform. It should also be understood that the plug-in launches the background viewer application/process (70), together forming the present invention. Once the viewer application/process (70) has been launched, other plugins or applications may access the viewer application/process (70), which can then drive GUI from other third party applications to other ‘host’ applications without starting another instance of the invention.

The plug-in user experience provided by the present invention may be further improved using Cloud technology. With several servers distributed on edge locations around the world, users can connect to the server closest to them. This significantly reduces the time required to download the plug-in and the viewer binaries and thus the time for installation.

Once the plug-in is installed and is initiated, it can connect to an application proxy also running on the closest edge location server. A significant part of the application protocol can be handled between the plug-in and the application proxy, minimizing the communication with central servers, that are typically much farther away and have significantly longer response times. The result is again an improved and more immersive experience for the plug-in user, as content displayed within the plug-in is loading faster and the plug-in can respond quicker to user interactions.

Finding the closest edge location server for each user requires an optimized Domain Name System (DNS) server for the Internet domain the plug-in is connecting to. The DNS server must be enabled to send different responses, depending on network latency or geo location, directing the user to the edge location server that results in the best user experience.

The number of active plug-in users varies greatly over the day or even over the days of a week; so the load on the servers the plug-in connects to also varies greatly, resulting in slower response times and degraded plug-in user experience during peak hours. This can be remedied by starting additional on-demand Cloud computing instances. The advantage of these on-demand instances is that additional computing power is quickly available to distribute peak server loads. Registering and deregistering the on-demand instances with the above-mentioned DNS servers or with a load balancer allows to-scale computing power flexibly, closely following the server load variations.

For example, Amazon™ services could be employed to implement the Cloud features described above. These Amazon™ services include ‘Amazon CloudFront’ for downloads, ‘Amazon Elastic Compute Cloud (EC2)’ for application proxies, ‘Amazon Route 52’ for DNS with ‘Latency Based Routing,’ and ‘Elastic Load Balancing.’

To further integrate the viewer application/process into the browser and make the plug-in user experience appear even closer to a conventional web page, the plug-in can define additional Javascript functions and Javascript events. In one direction, the Javascript code that is part of the web page calls such a function, which is implemented in the plug-in code; the plug-in communicates with the viewer application/process (70) using known inter-process communication and thus, code in the viewer application/process (70) can be called from Javascript code contained in the web site. In the other direction, code in the viewer application/process (70) can communicate with the plug-in using inter-process communication; the plug-in then fires a Javascript event that results in executing Javascript code contained in the web page and thus, Javascript code in the web page can be called from code in the viewer application/process (70).

These mechanisms can, for example, be used to supplement the content displayed in the plug-in browser window with actual web content such as images, events, ratings, etc. depending on the context currently displayed in the plug-in window (30). The web content can be updated dynamically to reflect changes in the viewer application/process (70) and the viewer application/process (70) can react to changes in the web content.

In summation, the process of the present invention as experienced by the user, shown in FIG. 2, is reiterated as follows: first, the user navigates to a website (110). The website is serving content that is beyond the capacity of a conventional browser (120). In order for the user to experience this content, a plug-in download link appears (130). The user is prompted to download a browser plug-in, preferably from a secure server (140). The browser plug-in download includes the viewer application/process. Both the plug-in and the viewer application/process are downloaded simultaneously if necessary (150). The browser plug-in and the viewer application/process are installed to the user's local computer automatically after download (160). Next, after installation is complete, the user may optionally restart the browser, however it is not necessary to complete the installation (170). If the user optionally restarted the browser, the user may optionally return to the web content the user initially attempted to view online (180). Henceforth, the plug-in is contextually sensitive as the user browses the internet, and is trigger or initialized by web content that necessitates the use of the present invention (190). The plug-in initialization process is preferably triggered by a HTML <object> tag within the webpage source code (200). The viewer application/process forms an administrative link with the ‘foreign’ application child window, or proxy, and the browser desktop window. This administrative link is accomplished via the plug-in (210). The plug-in remains active, running in the background after creating the administrative link. (220). The viewer application/process (70) then handles the bulk of the processing (230). Full, unrestricted application content is superimposed on to a ‘foreign’ application child window, including graphical and text interactivity (240). The ‘foreign’ application is now running with the browser window (250). The user now has access to the desired interactive service within a framework that feels secure (260). Web designers and programmers are now free to author code to the more lenient operating system standards, while still displaying their work within the framework of a browser or other target application (270).

To reiterate, the present invention is a method for displaying content on a computer for a user, comprising: the computer prompting a user to install a plug-in on a first computer application, the first computer application running on the computer, the plug-in functioning contemporaneously with a second computer application install on the computer, the computer installing a viewer application/process for the user, the viewer application/process displaying the superimposition of content from the first computer application onto the second computer application equipped with the plug-in, the viewer application/process (70) establishing an administrative link to the first computer application, the viewer application/process (70) establishing an administrative link to the second computer application, the viewer application/process (70) acting as a bridge between the first computer application and the second computer application via said administrative link, the computer mitigating content from the first computer application to the second computer application via an administrative link established by the viewer application/process, the computer portraying GUI elements of the first computer application within the confines of the second computer application as a proxy window, and the viewer application/process continuing to run as a background process on the computer. The viewer application/process (70) establishes an administrative link between the first computer application and the second computer application. The viewer application/process (70) superimposes the GUI elements of the first computer application over the second computer application, and conveys mouse and keyboard events accordingly.

The present invention may also be seen as a system for interactively displaying a first computer application within a second computer application, having at least one secured server computer, a viewer application/process, and a plug-in designed to function within the second computer application. The viewer application/process (70) is in communication with the plug-in. An administrative link is formed between an application core (60) of the first application and the browser plug-in running with said second application. The second computer application is displayed within a conventional window of a conventional operating system. A proxy window (40) within the second application is populated with GUI content and input/output capabilities of said first application. The first application GUI is superimposed onto the conventional window of the second application, such that both the first application and the second application appear seamlessly indistinguishable, acting as a proxy window (40) and input/output path for the first application.

It is to be understood that the present invention is not solely limited to the invention as described in the embodiments above, but further comprises any and all embodiments within the scope of the claims listed below.

I claim:

1. A method for displaying content on a computer for a user, comprising:
the computer prompting a user to install a plug-in on a first computer application, the first computer application running on the computer;
the plug-in functioning contemporaneously with a second computer application installed on the computer;
the computer installing a viewer application/process for the user;
the viewer application/process displaying the superimposition of content from the first computer application onto the second computer application equipped with the plug-in;
the viewer application/process establishing an administrative link to the first computer application;
the viewer application/process establishing an administrative link to the second computer application;
the viewer application/process acting as a bridge between the first computer application and the second computer application via said administrative link;
the computer mitigating content from the first computer application to the second computer application via an administrative link established by the viewer application/process;
the computer portraying GUI elements of the first computer application within the confines of the second computer application as a proxy window; and,
the viewer application/process continuing to run as a background process on the computer.

2. The method of claim 1, further comprising:
the viewer application/process establishing an administrative link between the first computer application and the second computer application.

3. The method of claim 1, further comprising:
the viewer application/process superimposing the GUI elements of the first computer application over the second computer application.

4. The method of claim 2, further comprising:
the viewer application/process superimposing the GUI elements of the first computer application over the second computer application.

5. A system for interactively displaying a first computer application within a second computer application, comprising:
at least one secured server computer;
a viewer application/process; and
a plug-in designed to function within the second computer application.

6. The system for interactively displaying a first computer application within a second computer application of claim 5, wherein the viewer application/process is in communication with the plug-in.

7. The system for interactively displaying a first computer application within a second computer application of claim 6, further comprising:
forming an administrative link between an application core process of the first application and the browser plug-in running within said second application.

8. The system for interactively displaying a first computer application within a second computer application of claim 7, wherein the first computer application is equipped with GUI elements including keyboard and mouse input.

9. The system for interactively displaying a first computer application within a second computer application of claim 5, wherein the second computer application is displayed within a conventional window of a conventional operating system.

10. The system for interactively displaying a first computer application within a second computer application of claim 5, wherein a proxy window within the second application is populated with GUI content and input/output capabilities of said first application.

11. The system for interactively displaying a first computer application within a second computer application of claim 9, wherein the first application GUI is superimposed onto the conventional window of the second application, such that both the first application and the second application appear seamlessly indistinguishable, acting as a proxy window and input/output path for the first application.

12. A system for interactively displaying a first computer application within a second computer application of claim 5,
wherein the viewer application/process is in communication with the plug-in; further comprising:
forming an administrative link between an application core process of the first application and the browser plugin running within the second application;
wherein the first computer application is equipped with GUI elements including keyboard and mouse input;
wherein the second computer application is displayed within a conventional window of a conventional operating system;
wherein a proxy window within the second application is populated with GUI content and input/output capabilities of said first application; and
wherein the first application GUI is superimposed onto the conventional window of the second application, such that both the first application and the second application appear seamlessly indistinguishable, acting as a proxy window and input/output path for the first application.

13. A method for displaying content to a user on a computer, comprising:
the user installing a plug-in on a first computer application, the first computer application running on the computer;
the plug-in functioning contemporaneously with the second computer application,
the user installing a viewer application/process;
the viewer application/process enabling the superimposition of content from the first computer application onto the second computer application equipped with the plug-in,
the plug-in establishing an administrative link between the first computer application and the second computer application;
the computer mitigating content from the first computer application to the second computer application via the administrative link; and
the computer portraying GUI elements of said first computer application within the confines of said second computer application via a proxy window.

14. The method for displaying content to a user on a computer of claim 13, wherein the viewer application/process has an application core.

15. The method for displaying content to a user on a computer of claim 14, wherein the application core is administratively linked to the first computer application and the proxy window.

16. The method for displaying content to a user on a computer of claim 13, wherein the viewer application/process has an application core; and
wherein the application core is administratively linked to the first computer application and the proxy window.
